(19) United States
(12) Patent Application Publication
(10) Pub. No.: US 2007/0135112 A1
(43) Pub. Date: Jun. 14, 2007

(54) Method for configuring the functionality of a mobile multimedia or communication device

(76) Inventor: Simon R. Lessing, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/325,700

(22) Filed: Jan. 5, 2006

Related U.S. Application Data
(60) Provisional application No. 60/749,694, filed on Dec. 13, 2005.

(51) Int. Cl. H04M 3/00

(52) U.S. Cl. 455/418

(57) ABSTRACT

A method for configuring the functionality of a mobile multimedia or communication device. For selecting and/or activating a specific function of the device, a programming element is placed into the vicinity of said multimedia or communication device, said programming element being able to wirelessly communicate via a localized communication link (e.g., near field communication (NFC)) with a control unit being located within the multimedia or communication device. After establishing a communication link between said programming element and said multimedia or communication device, a configuration information is transmitted from the programming element to said control unit. The control unit may control the functionality of said multimedia or mobile communication device in accordance with said received configuration information.

### RELATED APPLICATION DATA

The present application claims the benefit of U.S. Provisional Application Ser. No. 60/749,694, filed Dec. 13, 2005, the disclosure of which is herein incorporated by reference in its entirety.

### TECHNICAL FIELD OF THE INVENTION

The present invention relates to a method for configuring the functionality of a mobile multimedia or communication device, in particular of a mobile phone, wherein said multimedia communication device provides a plurality of different applications and/or functions to a user. Furthermore, the present invention also relates to a mobile multimedia or communication device which is adapted to be configured in accordance with the inventive method.

### DESCRIPTION OF RELATED ART

Modern mobile communication devices, such as mobile phones, do not only provide the possibility to establish communication links for telephone conversation but offer a plurality of additional multimedia applications and/or functions which a user of the communication device can use. For example, many mobile phones now offer the possibility to use them as MP3 players for listening to music. Further, integrated cameras sometimes provide the possibility to take pictures and forward them to other phones via communication links. Additional software is also offered for administrating, e.g., data referring to address information of other persons. Also, other multimedia applications like computer games or the like are available for users of mobile phones.

In view of the ongoing further development of mobile communication devices, a high number of different applications and/or functions are available for a user. However, in most cases only a relatively low number of these functions and/or applications are actually used by the owner of a device. The other applications and/or functions are not used but result in a very complex controlling menu when a user wants to select and activate a specific application.

In order to decrease the effort to select a specific application and/or function, a new concept has been developed regarding the system for controlling a communication device, in particular a mobile phone. This concept, referred to as “build-your-own-phone,” allows the user to configure his or her device to support exactly those features the user wants to use. This concept, therefore, can increase the usability of the device by getting rid of a lot of additional functions and/or applications that the user does not intend to use. In this case, when the user presses the button for activating a control menu in order to select different applications or functions, only those applications or functions are available that have been initially identified during a setup procedure.

Thus, the concept of configuring the functionality of a mobile multimedia or communication device can lead to a much more convenient handling of said device. However, usually the users who would desire this feature the most are often not likely to understand how the device should be configured or set up at the beginning. Although there would be the possibility to provide a specific software available on a personal computer (PC) which could support the configuration of the mobile phone when the phone is connected to the PC, the development of such a software is very expensive and there again exists the problem that the user then has to connect the phone to the PC and initiate a corresponding communication link.

A related problem to the above explained configuration of the functionality of multimedia or communication devices is the download or activation of new application data. For example, providers of cellular communication networks often offer the possibility to download new ringtones for a mobile phone or new digital pictures which could be used as a background wallpaper for the screen of the phone. Again, the download of such data and the corresponding entry of such setup information is often considered as being too complicated for many users of the communication devices.

Accordingly, there is a need for a new way that allows users of mobile communication or multimedia devices to configure the functionality of their devices in a very easy, fast and intuitive way.

### SUMMARY

According to an aspect of the present invention, a method for configuring the functionality of a mobile multimedia or communication device includes

a) placing a programming element into the vicinity of said multimedia or communication device, said programming element being able to wirelessly communicate via a localized communication link with a control unit being located within the multimedia or communication device,

b) establishing a localized communication link between said programming element and said multimedia or communication device; and

c) transferring via the localized communication link a configuration information from the programming element to said control unit, wherein said control unit controls the functionality of said multimedia or communication device in accordance with said transferred configuration information.

In accordance with a preferred embodiment of the present invention, the mobile multimedia or communication device is a mobile telephone.

Aspects of the present invention are based on the idea of using a near field or localized communication technology in order to let users choose which functions and/or applications should be made available by said device. Instead of manually entering configuration data, the user now simply attaches a programming element to the casing of the multimedia or communication device in order to submit the corresponding configuration information. In this way, a more intuitive customization or configuration of the device is obtained since the programming element can, e.g., be represented by a sticker showing the kind of application which is activated by transmitting the corresponding configuration information to the control unit of the multimedia or communication device. In this way, a user can in a very easy way configure his device, almost like putting items into a shopping cart.

Preferably, the communication link between said programming element and said multimedia or communication device is automatically established when the programming element is placed within the vicinity of said multimedia or communication device. Alternatively, said communication link between said programming element and said multimedia or communication device is established upon an activation of an input element, (e.g. a key) of said multimedia or communication device.

According to a preferred embodiment of the present invention, the communication between the multimedia or communication device and the programming element is obtained by using a radio frequency identification (RFID) technique. In this embodiment, the programming element comprises an RFID tag while the control unit of the multimedia or communication device is connected to an RFID transceiver. The RFID tag contained in the programming element is preferably a so-called passive tag which requires no internal power source. Such tags can be easily produced and distributed to different users of the device allowing them to customize the communication or multimedia device in a very convenient way.

In case the programming element is represented by a passive RFID tag, the amount of data which can be stored on said programming element is limited. In this case, the programming element preferably only transfers a specific configuration information to the control unit of the multimedia or communication device wherein said configuration information identifies a specific application or function. However, additional data (e.g. application data referring to a new ringtone or a wallpaper) are not transmitted. The configuration information is then either used to activate a function or application on the basis of data which are already prestored in storing means (e.g., a memory) of said device or causes the control unit of the multimedia or communication device to download new application data from a central server. Again, the user can in a very visible and intuitive way activate new functions or applications without the need to enter setup information via the keypad of the device. Therefore, users which are inexperienced in entering setup data for customizing a device are nevertheless able to select and activate only those functions which they are interested in.

In a specific embodiment of the present invention, said application or function corresponding to said transmitted configuration information is only activated as long as said programming element is placed within the vicinity of said multimedia or communication device. In this case, said programming element is preferably attachable to said multimedia or communication device.

According to another aspect of the invention, a mobile multimedia or communication device includes:

a) a control unit for controlling the functionality of the multimedia or communication device; and

b) a transceiver for wirelessly receiving via a localized communication link configuration information emitted from a programming element which is placed within the vicinity of said communication device, wherein said control unit controls the functionality of said multimedia or communication device in accordance with said received configuration information.

Again, said mobile multimedia or communication device preferably is a mobile phone.

According to still another aspect of the invention, a programming element for a mobile multimedia or communication device includes a transponder for wirelessly transmitting stored data to the mobile multimedia or communication device when the programming element is positioned with respect to the mobile multimedia or communication device so that a localized communication link is established therewith, the transmitted data for use by a control unit of the mobile multimedia or communication device to control functionality of the mobile multimedia or communication device.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the present invention will be explained in more detail with respect to the accompanying drawings.

FIG. 1a schematically shows, as an embodiment of the present invention, the front view of a multimedia or communication device in the form of a mobile phone wherein a programming element in the form of an RFID tag is used in order to customize the functionality of said mobile phone.

FIG. 1b shows the side view of the mobile phone and programming element of FIG. 1a.

FIGS. 2a to 2d show the different steps of a method of configuring the functionality of a mobile phone according to the present invention.

### DETAILED DESCRIPTION OF EMBODIMENTS

The term “electronic equipment,” also referred to herein as “mobile multimedia or communication device,” includes portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus or the like.

Although the present invention will be explained in the following on the basis of an example referring to a mobile phone, a person skilled in the art will readily recognize that the teachings of the invention are not restricted to mobile phones and can be applied to any type of mobile multimedia or communication device which offers a plurality of different applications and/or functions and involves the entry of configuration or setup information in order to customize the functionality of said device. For example, the present invention could also be used in order to customize the functionality of a PDA.

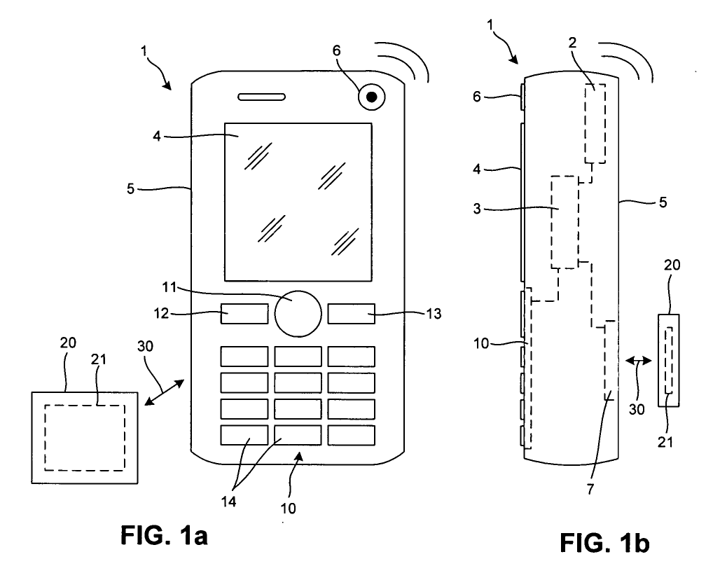

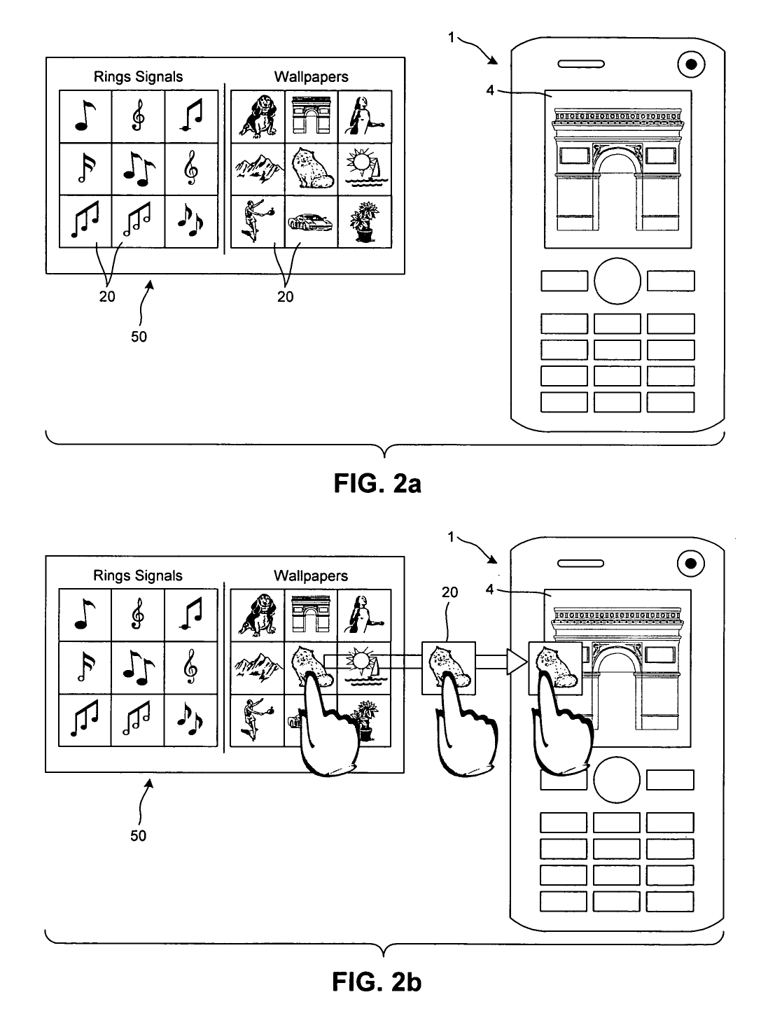

The mobile phone 1 shown in FIGS. 1a and 1b is at first intended for use for wireless telephone conversation and comprises communication means 2 (e.g., a radio circuit) for receiving and transmitting audio communication data via a cellular communication network (not shown). The function of the mobile phone 1 is generally controlled by a control unit 3. Status information informing of the actual status of the mobile phone 1 is shown on a display 4 which is located on the upper front part of a casing 5 of the phone 1. The display 4 is preferably a high resolution color display which can also be used with multimedia applications like camera applications or games that are nowadays often implemented in mobile phones as special features. For example, the phone 1 shown in FIGS. 1a and 1b includes a digital camera 6 which is located, in the illustrated embodiment, in the upper right comer of the front part of the casing 5.

The mobile phone 1 of FIGS. 1a and 1b further includes a key pad 10 having a central navigation key 11, two so-called “soft-keys” 12 and 13 and alphanumeric keys 14 for entering digits and characters. The functionality of the soft-keys 12 and 13 usually depends on the actual status of the mobile phone 1 and is shown in the corresponding lower part of the display 4.

Especially the navigation key 11 as well as the two soft keys 12 and 13 are primarily used in order to navigate through a controlling menu of the phone 1 in order to select and activate/deactivate specific functions and/or applications. Since mobile communication devices offer a high number of different applications and/or functions, the keys 11 to 13 conventionally are activated a plurality of times in a specific order in order to select and activate a specific function which the user wants to activate or manipulate in order to customize the functionality of the phone 1. In order to avoid this complicated procedure for customizing the functionality of the phone, a method for transmitting configuration information to said phone 1 which new method will be explained in the following.

As mentioned above, the method is based on the idea of using programming elements that are placed into the vicinity of the mobile phone 1 in order to transmit configuration data. Now, in contrast to manipulating the different keys of the key pad 10 in a complicated manner in order to activate or deactivate a specific function of the phone 1, the user may simply place the programming element close to the phone 1 which results in an automatic activation of the corresponding function or application.

In a preferred embodiment, a near field communication (NFC) technique is used to wirelessly transmit data via very short distances. For this, the control unit 3 of the mobile phone 1 is connected to a transceiver unit 7 which is also located within the casing 5 and which is able to establish an NFC communication link with programming elements that are located in the vicinity of the phone.

As shown in FIG. 1a and FIG. 1b, a programming element 20 has the form of a small platelet and includes a communication unit 21 which is able to communicate with the transceiver unit 7 of the mobile phone 1. The communication unit 21 of the programming element 20 also stores programming or customization data which are transferred to the mobile phone 1 and used by the control unit 3 in order to control the functionality of the phone 1. The communication unit 21 and the transceiver 7 establish a localized communication link 30.

Regarding the communication link 30 between the transceiver unit 7 of the mobile phone 1 and the communication unit 21 of the programming element 20, any appropriate near field communication technique can be used. As used herein, the term localized communication link includes capacitive coupling techniques, propagating wave (e.g., electromagnetic) techniques, magnetic field induction techniques and any other appropriate technique. Preferably communication via a radio frequency identification (RFID) technique is used. This technique is commonly used for automatic identification of items, e.g., in warehouses or the like. The RFID technique relies on the idea of storing and remote retrieving data using devices called RFID tags or transponders. An RFID tag is a small object (e.g., a sticker, a label, a card, etc.) that can be attached to or incorporated in a product. The RFID tag usually contains an antenna(s) to enable the tag to receive and respond to radio-frequency queries from an RFID transceiver. In the embodiment of the present invention, the RFID transceiver is represented by the transceiver unit 7 of the mobile phone 1 while the communication unit 21 of the programming element 20 represents the RFID tag.

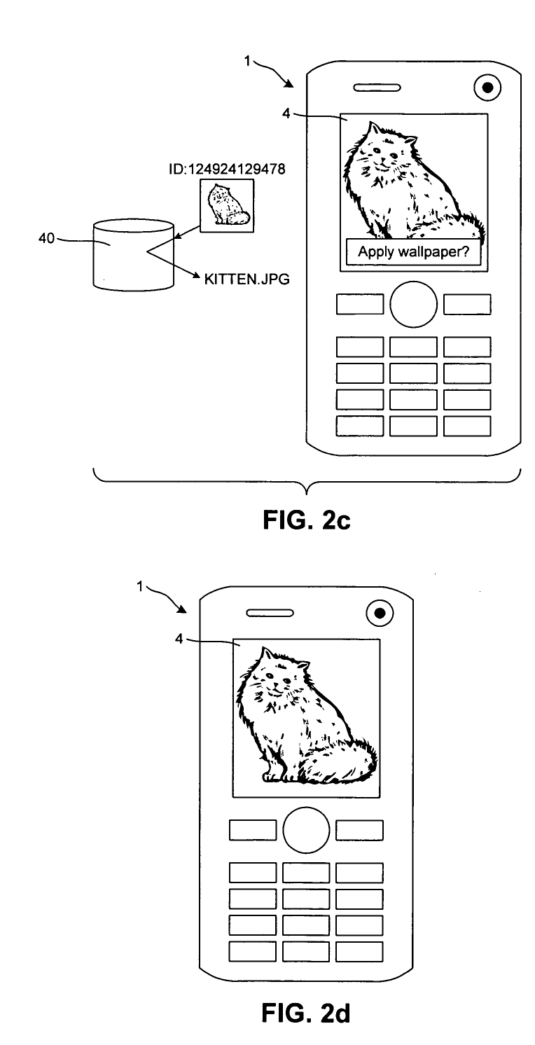

An advantage of using this RFID technique is that the communication unit 21 can be formed as a so-called passive RFID tag which requires no internal power source but uses the radio frequency waves transmitted from the transceiver unit 7 as a power source. A further advantage of using RFID technology is that the RFID tags can be formed as very compact and thin elements resulting in small size programming elements that can be made available to the user of the phone 1 in very different ways. For example, it would be possible to distribute programming elements via magazines or letters as will be explained later with reference to the example shown in FIG. 2.

Accordingly, in case a user does want to customize the functionality of the phone 1, the user simply attaches the programming element 20 to the casing 5 of the mobile phone 1 or brings the programming element 20 in sufficient transmission range. Now, a communication link 30 is established between the transceiver unit 7 and the programming element 21 which communication link 30 is used to transmit a customization or configuration information from the programming element 20 to the mobile phone 1. This configuration information is analyzed and used by the control unit 3 of the phone 1 in order to control the functionality of the phone 1 in accordance with the received information.

As an example, said configuration information could cause the control unit 3 to offer a specific selection of multimedia applications of the phone 1 to the user. The other applications, however, are suppressed in order to improve the handling of the phone 1. For example, the information transmitted by the programming element 20 could cause the control unit 3 to offer only applications that are related to telephone communication and management of address and phone number information. However, other multimedia applications like camera functions, games or MP3 player applications are suppressed which results in a very clear and manageable menu structure. In this way, the usability of the phone may be considered to some users as being improved.

Thus, a user can activate or deactivate specific functions of said mobile phone 1 in a very convenient way. In case the user would like to use additional applications or functions offered by the phone, the user simply may attach another corresponding programming element to the phone 1 in order to transmit the corresponding configuration information. Thus, the setup of the phone 1 can be carried out in a very convenient way similar to putting different items in a shopping cart.

As another example, FIGS. 2a to 2d show the different steps of customizing a mobile phone. The example shows the programming of the phone 1 in order to select a specific picture as background wallpaper for the display 4.

As shown in FIG. 2a, the mobile phone 1 at the beginning has a specific wallpaper shown on the display 4. The selection of this wallpaper is based on a default configuration when the phone is used for the first time. However, a plurality of different wallpapers are prestored in storing means (e.g., a memory) of the phone 1 which wallpapers could alternatively be selected by the user of the phone 1. Now, instead of the conventional approach of requesting the user to manipulate the keys of the keypad 10 in a particular manner in order to select a specific wallpaper, an album 50 is provided having a plurality of different programming elements 20 (e.g., in the form of stickers, labels or tags with or without adhesive) referring to the wallpapers which are available to the user. In a similar manner, different programming elements 20 could be made available which are related to different ringtones or ring signals that are offered by the phone 1.

In order to select a new wallpaper, a user now has to select the corresponding programming element 20 as shown in FIG. 2b and touch the casing of the phone 1 with this programming element 20. After the programming element 20 has been brought into the vicinity of the phone 1, the transceiver unit 7 will automatically detect the presence of the programming element 20 and establish a wireless near field communication link. Alternatively, the transceiver unit 7 could also be activated by pressing down a specific key of the key pad. This link is used by the RFID tag contained in the programming element 20 to transmit a specific ID number referring to the selected wallpaper.

As shown in FIG. 2c, the control unit of the phone 1 then accesses after the receipt of this ID number a data base 40 in which different graphic files are stored which graphic files correspond to different wallpapers. With the use of the ID number sensed by the transceiver unit of the phone 1, the control unit 3 generates a corresponding link to the data base 40 and selects the pre-stored file which is afterwards shown on the display 4. Additionally, a question is shown requesting the user to confirm the selection of this new picture before the wallpaper is changed. After the user has activated the corresponding key of the keypad, the wallpaper is changed by sending the data base match to an idle screen application as shown in FIG. 2d.

Accordingly, a user can select or activate specific wallpapers pre-stored in the storing means of the phone 1 in a very convenient and intuitive way. It is not necessary to activate the different keys of the keypad in a specific way in order to navigate through a plurality of menus and sub-menus. Instead, the user simply has to pick the corresponding programming element 20 and position the programming element 20 with respect to the phone (e.g., attach a sticker programming element to the phone).

In a similar way, it would also be possible to select new ring signals or ringtones by selecting the corresponding programming element 20 and touching it with the casing of the phone. Further, any type of phone content, from applications to ring signals, language and alarm on or off could be programmed in this way.

In the embodiment explained with reference to FIGS. 2a to 2d, the information transmitted from the programming element 20 to the mobile phone 1 is a specific ID number which was related to a data content pre-stored in storing means of the phone. This example refers to a preferred embodiment since only a low amount of data has to be stored on the programming element and transmitted to the phone. However, it would also be possible to transmit the whole data content from the programming element to the phone. In this case, the RFID tag would require a larger storing means in order to store, e.g., a complete graphic file which can be used as a wallpaper.

According to a further embodiment, it would also be possible that the ID transmitted from the programming element to the mobile phone 1 is used by the mobile phone 1 in order to download a specific data content from a provider of the cellular network which is used by the phone 1 for telephone conversation. Such a programming element 20 with the RFID tag could then be sent from the provider of the cellular network to the user of the corresponding phone which allows the provider to offer on a regular basis new application content data.

In the embodiment shown in FIGS. 1 and 2, the programming element 20 (referring to the selection of wallpaper) is only temporarily attached to the phone in order to transmit the configuration information. After the information has been transferred to the phone 1, the programming element 20 is removed from the vicinity of the phone. Alternatively, it would also be possible to require the programming element 20 to be permanently applied in order to activate the corresponding function and/or application. In this embodiment, the programming element 20 could, e.g., be attached to the backside of the casing by using an adhesive or other connecting mechanisms. Thus, a user would be allowed to attach a specific number of different programming elements in order to customize the functionality of the phone.

In summary, the present invention provides a method and system for customizing the functionality of a multimedia or communication device in a very convenient way. Instead of a complicated entry of different configuration data by using the keypad of the device, the method and system allow the user to easily select, activate or deactivate specific functions or applications.

What is claimed is:

1. A method for configuring the functionality of a mobile multimedia or communication device, said method comprising the steps of:
a) placing a programming element into the vicinity of said multimedia or communication device, said programming element being able to wirelessly communicate via a localized communication link with a control unit being located within the multimedia or communication device;
b) establishing a localized communication link between said programming element and said multimedia or communication device; and
c) transferring via the localized communication link a configuration information from the programming element to said control unit, wherein said control unit controls the functionality of said multimedia or communication device in accordance with said transferred configuration information.

2. The method of claim 1, wherein said communication device is a mobile phone.

3. The method of claim 1, wherein said localized communication link between said programming element and said multimedia or communication device is automatically established when the programming element is placed within the vicinity of said multimedia or communication device.

4. The method of claim 1, wherein said localized communication link between said programming element and said multimedia or communication device is established upon an activation of an input element of said multimedia or communication device.

5. The method of claim 1, wherein said localized communication link is based on an RFID technique.

6. The method of claim 5, wherein said multimedia or communication device comprises and RFID transceiver and said programming element comprises a passive RFID tag.

7. The method of claim 1, wherein said configuration information transmitted to said multimedia or communication device causes the control unit to activate or deactivate a specific application or function of said device.

8. The method of claim 7, wherein said application or function corresponding to said transmitted configuration information is only activated as long as said programming element is placed within the vicinity of said multimedia or communication device.

9. The method of claim 8, wherein said programming element is attachable to said multimedia or communication device.

10. The method of claim 1, wherein said configuration information transmitted to said multimedia or communication device causes the control unit to access application content data prestored in storing means of said multimedia or communication device.

11. The method of claim 1, wherein said configuration information transmitted to said multimedia or communication device causes the control unit to download application content data from a server.

12. A mobile multimedia or communication device comprising:
a) a control unit for controlling the functionality of the multimedia or communication device; and
b) a transceiver for wirelessly receiving via a localized communication link configuration information emitted from a programming element which is placed within the vicinity of said communication device,
wherein said control unit controls the functionality of said multimedia or communication device in accordance with said received configuration information.

13. The mobile multimedia or communication device of claim 12, wherein said communication device is a mobile phone.

14. The mobile multimedia or communication device of claim 12, wherein said localized communication link between said programming element and said multimedia or communication device is automatically established when the programming element is placed within the vicinity of said multimedia or communication device.

15. The mobile multimedia or communication device of claim 12, wherein said localized communication link between said programming element and said multimedia or communication device is established upon an activation of an input element of said multimedia or communication device.

16. The mobile multimedia or communication device of claim 12, wherein said localized communication link is based on an RFID technique.

17. The mobile multimedia or communication device of claim 12, wherein said transceiver is an RFID transceiver.

18. The mobile multimedia or communication device of claim 12, wherein said configuration information transmitted to said multimedia or communication device causes the control unit to activate or deactivate a specific application or function.

19. The mobile multimedia or communication device of claim 18, wherein said application or function corresponding to said transmitted configuration information is only activated as long as said programming element is placed within the vicinity of said multimedia or communication device.

20. The mobile multimedia or communication device of claim 12, wherein said configuration information transmitted to said multimedia or communication device causes the control unit to access application content data prestored in storing means of said multimedia or communication device.

21. The mobile multimedia or communication device of claim 12, wherein said configuration information transmitted to said multimedia or communication device causes the control unit to download application content data from a server.

22. A programming element for a mobile multimedia or communication device, comprising a transponder for wirelessly transmitting stored data to the mobile multimedia or communication device when the programming element is positioned with respect to the mobile multimedia or communication device so that a localized communication link is established therewith, the transmitted data for use by a control unit of the mobile multimedia or communication device to control functionality of the mobile multimedia or communication device.

23. The programming element of claim 22, wherein the transponder includes an RFID communication unit.

24. The programming element of claim 22, wherein the mobile multimedia or communication device is a mobile phone.
